(19) United States
(12) Patent Application Publication
(10) Pub. No.: US 2009/0302118 A1
(43) Pub. Date: Dec. 10, 2009

(54) CARD READER

(76) Inventor: Cheng-Yi Chen, Chung Ho City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/136,259

(22) Filed: Jun. 10, 2008

(51) Int. Cl. G06K 13/00

(52) U.S. Cl. 235/482

(57) ABSTRACT

A card reader includes: an insulating casing having a plurality of terminal openings, a plurality of first insertion slots and a plurality of second insertion slots, the terminal openings being provided at a rear end of the insulating casing, the first insertion slots being provided at intervals on upper ends of the terminal openings, the second insertion slots being provided at intervals on lower ends of the terminal openings; a plurality of first conductive terminals lodged in the first insertion slots of the insulating casing respectively; and a plurality of second conductive terminals lodged in the second insertion slots of the insulating casing respectively. Via this arrangement, the thickness of side walls of the first insertion slots and the second insertion slots is larger, so that the side walls of the first insertion slots and the second insertion slots may not crack easily during formation.

### BACKGROUND OF THE INVENTION

1. Field of the Invention

The present invention relates to a card reader which is applicable to access data in electronic cards.

2. Description of Related Art

With the progress of technology, electronic cards have become a popular medium for storing and identifying information. A user can store personal information in an electronic card. Subsequently, the specific information stored in the electronic card can be read and used. For example, Smart Cards (i.e. integrated circuit card, ICC) are used to pay for public transportation, credit cards are used for general payments cash, and electronic identity cards (eID) are used in health insurance systems. With the increasing usage of electronic cards, the demand for card readers is also increases accordingly. Therefore, it is an important issue for those skilled in this art to provide a card reader with a high quality and reasonable price.

FIG. 1 shows a conventional card reader, which includes an insulating casing 10A, a plurality of front row conductive terminals 11A and a plurality of rear row conductive terminals 12A. The rear end of the insulating casing 10A has a plurality of terminal insertion slots 13A in which the front row conductive terminals 11A and the rear row conductive terminals 12A can be lodged.

However, the conventional card reader has problems as follows.

Since the front row conductive terminals 11A and the rear row conductive terminals 12A are arranged densely, the terminal insertion slots 13A also have to be arranged densely, which necessitates a reduced thickness of side walls of the terminal insertion slots 13A. As a result, the side walls of the terminal insertion slots 13A may crack during manufacture, which increases the probability of defects.

Further, the thinner side wall of the terminal insertion slot 13A makes the terminal insertion slot 13A unable to withstand too large stress. Therefore, when a larger engaging force is applied between the conductive terminals 11A, 12A and the terminal insertion slots 13A, which means the amount of interference between the conductive terminals 11A, 12A and the terminal insertion slots 13A is larger, the side walls of the terminal insertion slots 13A may crack easily.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a card reader, in which the structural strength of the insulating casing is better.

In order to achieve the above objects, the present invention provides a card reader including: an insulating casing having a plurality of terminal openings, a plurality of first insertion slots and a plurality of second insertion slots, the terminal openings being provided at a rear end of the insulating casing, the first insertion slots being provided at intervals on upper ends of the terminal openings, the second insertion slots being provided at intervals on lower ends of the terminal openings; a plurality of first conductive terminals lodged in the first insertion slots of the insulating casing respectively; and a plurality of second conductive terminals lodged in the second insertion slots of the insulating casing respectively.

The present invention has advantageous features as follows. The thickness of the side walls of the first insertion slots and the second insertion slots is larger, the first insertion slots and the second insertion slots will not crack easily during formation. Further, the side walls of the first insertion slots and the second insertion slots can withstand a larger engaging force.

In order to further understand the characteristics and technical contents of the present invention, a detailed description relating thereto will be made with reference to the accompanying drawings. However, the drawings are illustrative only, but not used to limit the scope of the present invention.

### BRIEF DESCRIPTION OF THE DRAWINGS

FIG. 1 is a cross-sectional perspective view showing a conventional card reader;

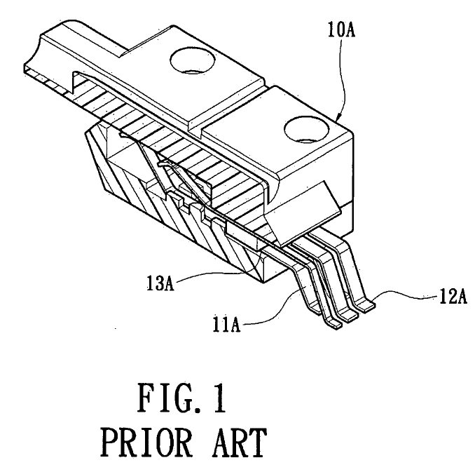

FIG. 2 is a perspective view showing the card reader of the present invention;

FIG. 3 is a perspective view showing the card reader of the present invention along another viewing angle;

FIG. 4 is an exploded perspective view showing the card reader of the present invention;

FIG. 5 is a plan view showing the insulating casing of the card reader of the present invention;

FIG. 6 is a perspective view showing an operating state of the card reader of the present invention; and

FIG. 7 is a cross-sectional view showing an operating state of the card reader of the present invention.

### DETAILED DESCRIPTION OF THE PREFERRED EMBODIMENTS

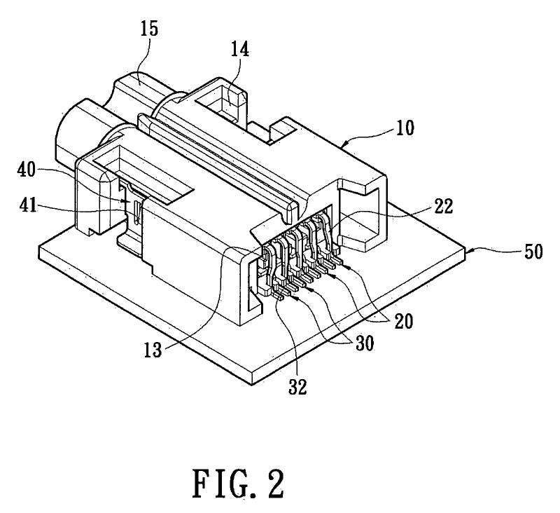

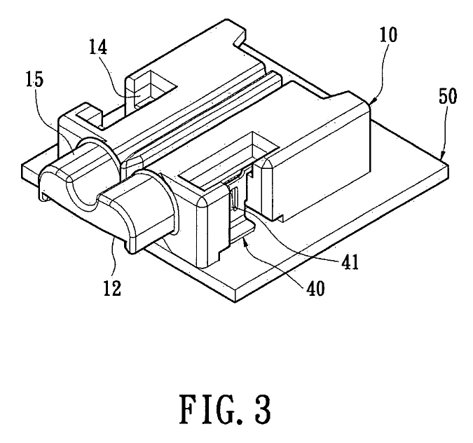

Please refer to FIGS. 2 and 3. The present invention provides a card reader, which includes an insulating casing 10, a plurality of first conductive terminals 20, a plurality of second conductive terminals 30, two locking pieces 40 and a circuit board 50.

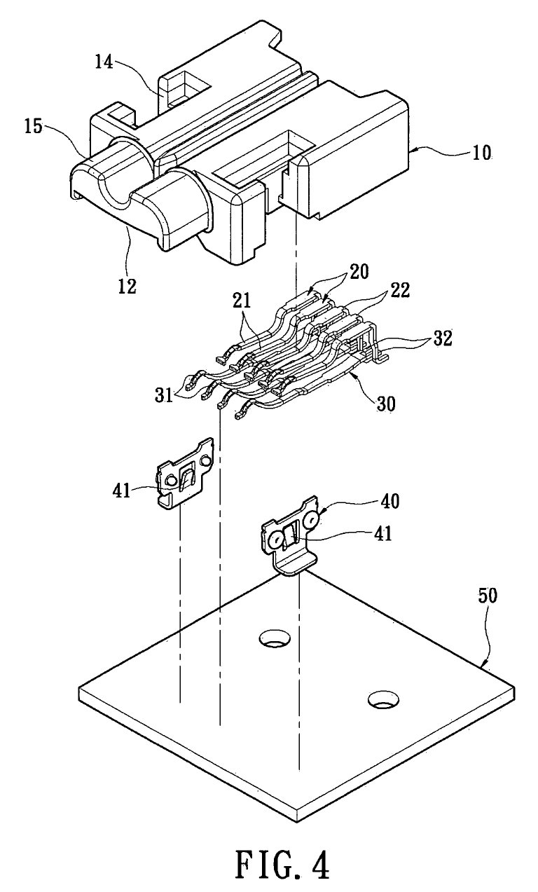

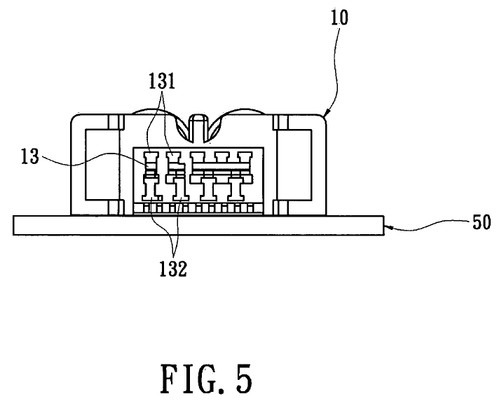

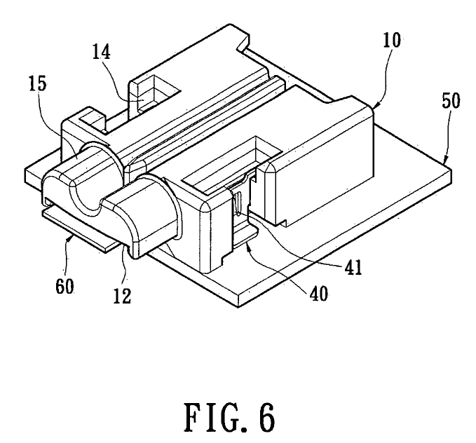

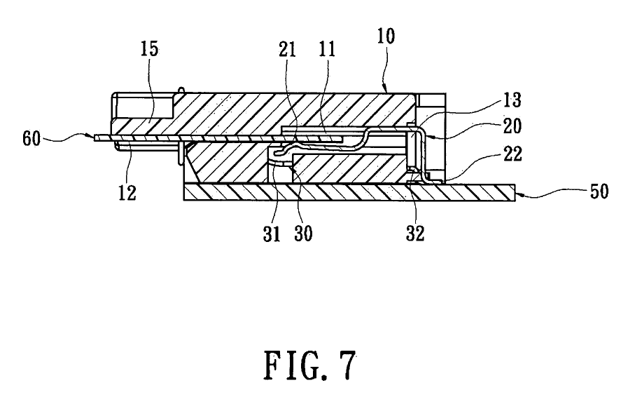

Please refer to FIGS. 4 and 5. The insulating casing 10 is integrally formed of an insulating material (such as plastic) by means of injection molding. The interior of the insulating casing 10 has a space 11. The front end of the insulating casing 10 is provided with a rectangular opening 12. The opening 12 is in communication with the space 11. An electronic card (FIGS. 6 and 7) extends into the space 11 of the insulating casing 10 via the opening 12 (FIG. 7).

The rear end of the insulating casing 10 is provided with a plurality of terminal openings 13 that are in communication with the space 11. Upper ends of the terminal openings 13 are provided at intervals with a plurality of first insertion slots 131, so that the upper ends of the terminal openings 13 are formed into an approximate T-shaped slot respectively. Lower ends of the terminal openings 13 are provided at intervals with a plurality of second insertion slots 132, so that the lower ends of the terminal openings 13 are formed into an approximate inverted. T-shaped slot respectively (in FIG. 5, the first insert slots 131 and second insert slots 132 taken into account of the terminal openings 13 that covers up part of the slots would forms into T-shape and inverted T-shape, for example, first insert slot 131 looks undoubtedly like “T” due to the terminal opening 13 covering, second insertion slots 132 would look like an “inverted T” instead of “I” too taking into account of the terminal opening 13 covering).

A protruding portion 15 extends from the front end of the insulating casing 10. The protruding portion 15 is located above the opening 12 for guiding a user to insert the electronic card into the insulating casing 10 via the opening 12.

The first conductive terminals 20 are made of metals having a high conductivity. The first conductive terminals 20 are inserted into the terminal openings 13 from the rear of the insulating casing 10 and are lodged into the first insertion slots 131 of the terminal openings 13. The front ends of the first conductive terminals 20 each extend downwards and forwards to form a curved-shaped first contacting portion 21. The first contacting portions 21 are received in the space 11 of the insulating casing 10. The rear ends of the first contacting portions 21 each extend downwards and rearwards to form an L-shaped first soldering portion 22. The rear ends of the first soldering portions 22 extend to the rear of insulating casing 10.

The second conductive terminals 30 are also made of metals having a high conductivity. The assembly of the second conductive terminals 30 is similar to that of the first conductive terminals 20. That is, the second conductive terminals 30 are inserted in the terminal openings 13 from the rear of the insulating casing 10 and are lodged in the second insertion slots 132. The front ends of the second conductive terminals 30 each extend to form a curved-shaped second contacting portion 31. The first contacting portions 21 and the second contacting portions 31 are arranged in the insulating casing 10 horizontally and alternatingly. The front ends of the second contacting portions 31 are located in front of the front ends of the first contacting portions 21.

For clarity of alternating arranged, FIG. 4 has five first contacting portions 21 and four second contacting portions 31, there is one second contacting portion 31 between and below each pair of first contacting portions 21.

The rear ends of the second conductive terminals 30 each extend to form an L-shaped second soldering portion 32. The rear ends of the second soldering portions 32 extend to the rear of the insulating casing 10. Further, the first soldering portions 22 and the second soldering portions 32 are arranged horizontally and alternatingly. The very rear ends of the first soldering portions 22 and the very rear ends of the second soldering portions 32 are located on the same vertical plane.

Both sides of the insulating casing 10 each have a locking slot 14 for receiving the locking piece 40. The locking piece 40 is provided thereon with an elastic piece 41 that is capable of generating a suitable elastic force. When the locking piece 40 is inserted into the locking slot 14 from the upside of the insulating casing 10, the elastic piece 41 will be deformed elastically to generate a force for abutting the locking piece 40 against the surface of the locking slot 14 tightly, so that the locking piece may not be removed from the locking slot 14 easily.

After the first conductive terminals 20, the second conductive terminals 30 and the locking pieces 40 are assembled with the insulating casing 10, the circuit board 50 is disposed on the underside of the insulating casing 10. The first soldering portions 21 of the first conductive terminals 20 and the second soldering portions 32 of the second conductive terminals 30 are soldered with corresponding contacts (not shown) on an upper end of the circuit board 50. In this way, the conductive terminals 20, 30 can be electrically connected with the circuit board.

The lower ends of the locking pieces 40 can be also soldered on the upper end of the circuit board 50, thereby fixedly connecting the locking pieces 40 with the circuit board 50. The locking pieces 40 lock the insulating casing 10 firmly, so that the insulating casing 10 can be disposed on the circuit board 50 firmly. As a result, the insulating casing 10 will not shake with respect to the circuit board 50.

Please refer to FIGS. 6 and 7. When the electronic card 60 is inserted into the insulating casing 10 via the opening 12, the connecting contacts (not shown) of the electronic card 60 are brought into contact with the first contacting portions 21 of the first conductive terminals 20 and the second contacting portions 31 of the second conductive terminals 30. The data stored in the electronic card 60 can be transmitted to the circuit board 50 via the conductive terminals 20, 30, so that the data can be processed by other electronic devices connected on the circuit board 50.

The present invention has advantageous effects as follows.

(I) The first insert slots 131 and the second insertion slots 132 are arranged at intervals in the terminal openings 13 and are provided at upper and lower ends of the terminal openings 13 respectively. In this way, the upper and lower ends of the terminal openings 13 are formed into T-shape and inverted T-shape slots. Therefore, the thickness of side walls of the first insertion slots 131 and the second insertion slots 132 is larger. Thus, when the first insertion slots 131 and the second insertion slots 132 are manufactured, the side walls thereof may not crack easily.

(II) Since the thickness of the side walls of the first insertion slots 131 and the second insertion slots 132 is larger, they can withstand a larger engaging force, which means the amount of interference between the terminal and the insertion slot is larger. Therefore, the first conductive terminals 20 and the second conductive terminals 30 can be lodged in the first insertion slots 131 and the second insertion slots 132 firmly.

(III) The rear ends of the first soldering portions 22 of the first conductive terminals 20 and the rear ends of the second soldering portions 32 of the second conductive terminals 30 are located on the same vertical plane which means that planarity of the first conductive terminals 20 and the second conductive terminals 30 are well. Therefore, when the first soldering portions 22, and the second soldering portions 32 are soldered on the circuit board 50, the soldering process can be performed more easily in comparison with the case that the soldering portions are not located on the same plane.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A card reader, comprising;
an insulating casing having a rear end, an underside and a plurality of terminal openings, a plurality of first insertion slots and a plurality of second insertion slots, the terminal openings being provided at the rear end of the insulating casing, the first insertion slots being provided at intervals on upper ends of the terminal openings, the second insertion slots being provided at intervals on lower ends of the terminal openings;
a plurality of first conductive terminals lodged in the first insertion slots of the insulating casing respectively; and
a plurality of second conductive terminals lodged in the second insertion slots of the insulating casing respectively.

2. The card reader according to claim 1, wherein front ends of the first conductive terminals extend forwards to each form a first contacting portion, front ends of the second conductive terminals extend forwards to each form a second contacting portion, the first contacting portions and the second contacting portions being received in the insulating casing.

3. The card reader according to claim 2, wherein the rear ends of the first conductive terminals extend downwards and rearwards to each form a first soldering portion, the rear ends of the second conductive terminals extend downwards and rearwards to each form a second soldering portion, the first soldering portions and the second soldering portions extending to the rear of the insulating casing.

4. The card reader according to claim 3, wherein the first contacting portions of the first conductive terminals and the second contacting portions of the second conductive terminals are arranged horizontally and alternatingly.

5. The card reader according to claim 3, wherein the first soldering portions of the first contacting terminals and the second soldering portions of the second conductive terminals are arranged horizontally and alternatingly.

6. The card reader according to claim 3 wherein the front ends of the second contacting portions of the second conductive terminals are located in front of the front ends of the first contacting portions of the first conductive terminals.

7. The card reader according to claim 3, wherein the rear ends of the first soldering portions of the first conductive terminals and the rear ends of the second soldering portions of the second conductive terminals are located on same vertical plane.

8. The card reader according to claim 3, further comprising a circuit board having an upper side and being arranged on the underside of the insulating casing, the first soldering portions of the first conductive terminals and the second soldering portions of the second conductive terminals being soldered on the upper side of the circuit board.

9. The card reader according to claim 8, wherein both sides of the insulating casing each have a locking slot, the card reader further comprises two locking pieces, the two locking pieces are locked in the locking slots of the insulating casing, and the lower ends of the two locking pieces are soldered on the upper side of the circuit board.
